(19) United States
(12) Patent Application Publication
(10) Pub. No.: US 2013/0235271 A1
(43) Pub. Date: Sep. 12, 2013

(54) DISPLAY DEVICE AND ON-SCREEN DISPLAY OPERATION METHOD

(71) Applicants: Hiroyuki Kasuga, Tokyo (JP); Tomohisa Ukegawa, Tokyo (JP)

(72) Inventors: Hiroyuki Kasuga, Tokyo (JP); Tomohisa Ukegawa, Tokyo (JP)

(21) Appl. No.: 13/880,030

(22) PCT Filed: Oct. 22, 2010
(86) PCT No.: PCT/JP2010/068706

§ 371 Date: May 20, 2013

(51) Int. Cl. H04N 5/445

(52) U.S. Cl. CPC H04N 5/44543
USPC 348/569

(57) ABSTRACT

A display device includes: a video display unit displaying an image; a first operation input unit detecting an operation performed by a user contacting a sensor in a first direction; a second operation input unit detecting an operation performed by a user contacting a sensor in a second direction differing from the first direction; a front bezel in which the first operation input unit and the second operation input unit are arranged apart on different sides; and a controller causing the video display unit to display on-screen display screen including a first hierarchy menu displayed corresponding to the first direction, and a second hierarchy menu displayed corresponding to the second direction. The controller selects the first hierarchy menu based on the operation detected by the first operation input unit. The controller selects the second hierarchy menu based on the operation detected by the second operation input unit.

### TECHNICAL FIELD

The present invention relates to a display device and an on-screen display operation method.

### BACKGROUND ART

There are display devices that have an OSD (on-screen display) function that allow adjustment of various settings such as brightness and contrast of the display screen while displaying a menu on a portion of the display screen (for example, refer to Patent Document 1 and Patent Document 2). In a display device that has an OSD function, it is possible to adjust various setting values while confirming the display on the display screen.

### PRIOR ART DOCUMENTS

### Patent Documents

[Patent Document 1] Japanese Unexamined Patent Application, First Publication No. H10-322727

[Patent Document 2] Japanese Unexamined Patent Application, First Publication No. 2007-11012

### SUMMARY OF THE INVENTION

### Problem to be Solved by the Invention

The OSD screen is displayed on the display screen when performing settings using the OSD function. This OSD screen is constituted from hierarchical menus. The main menu is the menu at the top level, and a category list of menu items is displayed. The sub-menu is a menu one level below the top level, and a list of menu items belonging to the category selected in the main menu is displayed. The user selects a menu item corresponding to the function to be set from a list of menu items that are displayed in the sub-menu, and performs the setting of the function.

In the aforementioned conventional display device, a rotary switch or buttons corresponding to right, left, up and down are provided on the front bezel (frame) around the display screen in order for the user to select the category and menu item from the menus on the OSD screen. For that reason, when selecting a menu item, the user turns the rotary switch, presses the buttons numerous times or holds down the buttons. For that reason, there has been a desire to make the operability when selecting a menu item on an OSD screen better than the operability that uses a conventional physical switch.

### Means for Solving the Problem

The present invention has been achieved in view of such circumstances, and provides a display device with improved operability when selecting a menu item on an on-screen display screen, and an on-screen display operation method.

### DISCLOSURE OF THE INVENTION

[1] The present invention provides a display device including: a video display unit that displays an image; a first operation input unit that detects an operation in a first direction, the operation performed by a user contacting a sensor; a second operation input unit that detects an operation in a second direction differing from the first direction, the operation performed by a user contacting a sensor; a front bezel in which the first operation input unit and the second operation input unit are arranged apart on different sides; and a controller that causes the video display unit to display on-screen display screen including a first hierarchy menu displayed corresponding to the first direction, and a second hierarchy menu displayed corresponding to the second direction, the controller performing a process of selection of the first hierarchy menu based on the operation detected by the first operation input unit, and the controller performing a process of selection of the second hierarchy menu based on the operation detected by the second operation input unit.

### Effect of the Invention

According to the present invention, the operability of an on-screen display screen is improved in a display device that has an OSD function.

### BRIEF DESCRIPTION OF THE DRAWINGS

FIG. 1 is a diagram that shows the outer appearance of a display device according to an exemplary embodiment of the present invention.

FIG. 2 is a function block diagram that shows the constitution of the display device.

FIG. 3 is a diagram that shows the display position of an OSD screen.

FIG. 4 is a diagram that shows the OSD screen in which a cursor position differs.

FIG. 5 is a diagram that shows the transition of the OSD screen.

FIG. 6 shows the operation flow of the display device.

FIG. 7 shows the operation flow of the display device.

### EMBODIMENTS FOR CARRYING OUT THE INVENTION

Hereinbelow, an exemplary embodiment of the present invention shall be described with reference to the appended drawings.

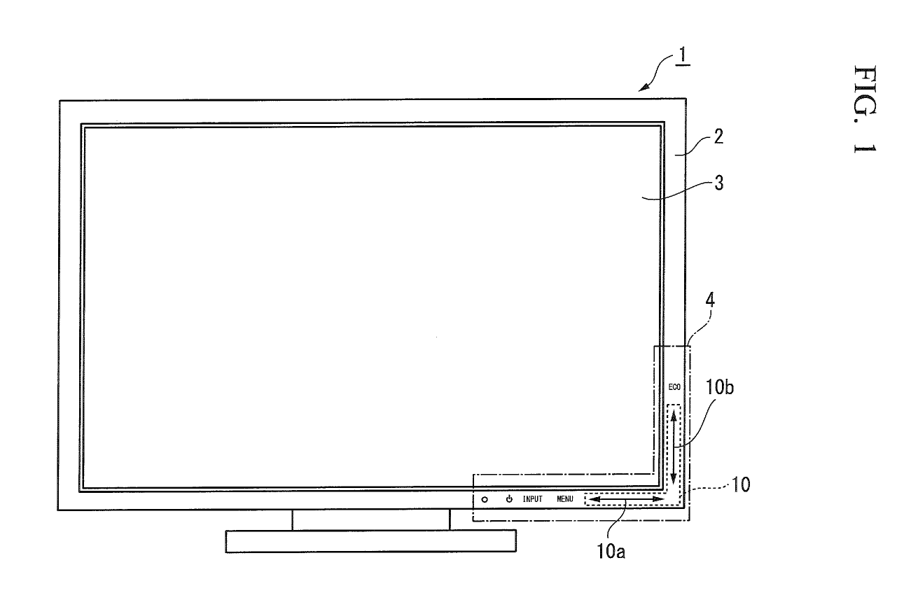

FIG. 1 is a diagram that shows the outer appearance of a display device 1 according to one exemplary embodiment of the present invention. As shown in the same figure, the display device 1 has a front bezel (frame) 2 around a display screen 3. Near the bottom-right corner of the front bezel 2, a control unit 4 is disposed. A slider control key 10 is provided as a portion of this control unit 4. This slider control key 10 includes a horizontal slider control key 10a that is arranged at the right end of the lower side of the front bezel 2, and a vertical slider control key 10b that is arranged at the lower end of the right side of the front bezel 2. In this way, the slider control key 10 is arranged across two adjoining sides of the front bezel 1 The slider control key 10 is a touch sensor that detects operations that the user performs by sliding a finger or the like. The horizontal slider control key 10a detects a leftward operation and a rightward operation, while the vertical slider control key 10b detects an upward operation and a downward operation.

The display device 1 has an OSD (on-screen display) function that can adjust various settings related to the display while displaying a menu in a portion of the display screen 3.

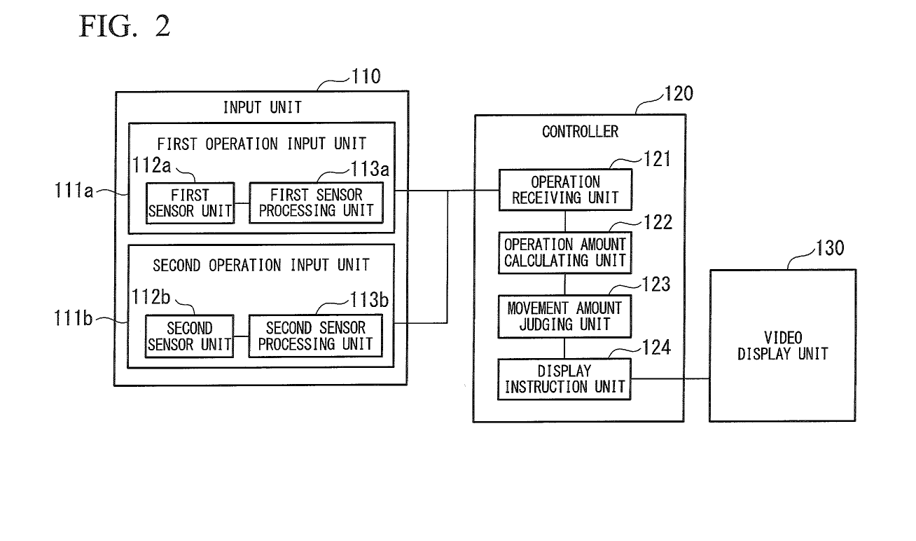

FIG. 2 is a function block diagram that shows the constitution of the display device 1 in the present exemplary embodiment, and illustrates by extracting the portions directly related to the present invention. The display device 1 shown in the same figure is configured by including an input unit 110, a controller 120, and a video display unit 130.

The input unit 110 is equivalent to the control unit 4 shown in FIG. 1, and receives the input of a user operation. The input unit 110 includes a first operation input unit 111a that includes a first sensor unit 112a and a first sensor processing unit 113a, and a second operation input unit 111b that includes a second sensor unit 112b and a second sensor processing unit 113b. The first operation input unit 111a is equivalent to the horizontal slider control key 10a shown in FIG. 1, and the second operation input unit 111b is equivalent to the vertical slider control key 10b shown in FIG. 1. The first sensor unit 112a and the second sensor unit 112b detect the start position and end position of a user operation. This user operation is performed by a user tracing the first sensor unit 112a or the second sensor unit 112b with a finger or the like. Specifically, a user brings a finger into contact with the first sensor unit 112a or the second sensor unit 112b and moves that finger while maintaining contact. The first sensor processing unit 113a outputs to the controller 120 information that shows the start position and end position of the user operation that the first sensor unit 112a has detected, and the second sensor processing unit 113b outputs to the controller 120 information on the start position and end position of a user operation that the second sensor unit 112b has detected.

The controller 120 is configured by including an operation receiving unit 121, an operation amount calculating unit 122, a movement amount judging unit 123, and a display instruction unit 124.

The operation receiving unit 121 receives information of an operation that has been performed by a user from the input unit 110. This information of the operation includes the start position and end position of a user operation outputted from the first sensor processing unit 113a, or the start position and end position of a user operation outputted from the second sensor processing unit 113b.

The operation amount calculating unit 122 calculates the input operation amount and input operation direction from the start position and end position of a user operation shown by the information that the operation receiving unit 121 has received. The input operation amount is the operation amount that a user has traced by a finger on the horizontal slider control key 10a or the vertical slider control key 10b, and corresponds to the distance between the start position and the end position of the user operation. The input operation direction is the operation direction that a user has traced with a finger on the horizontal slider control key 10a or the vertical slider control key 10b, and corresponds to the direction of the user operation from the start position to the end position.

The movement amount judging unit 123 judges the target cursor movement amount on the OSD screen from the input operation amount that the operation receiving unit 121 has calculated. The display instruction unit 124 outputs to the video display unit 130 an image signal for causing the OSD screen to be displayed when the cursor has been moved in accordance with the target cursor movement amount judged by the movement amount judging unit 123 and the input operation direction. Note that in the case of a video signal being input from another device that is connected with the display device 1, the display instruction unit 124 generates a video signal that displays an image superimposing the image of the OSD screen on the image of the video signal input from the other device, and outputs it to the video display unit 130.

The video display unit 130 is equivalent to the display screen 3 shown in FIG. 1, and for example, is a display such as an LCD (Liquid Crystal Display). The video display unit 130 displays a video in accordance with the video signal received from the controller 120.

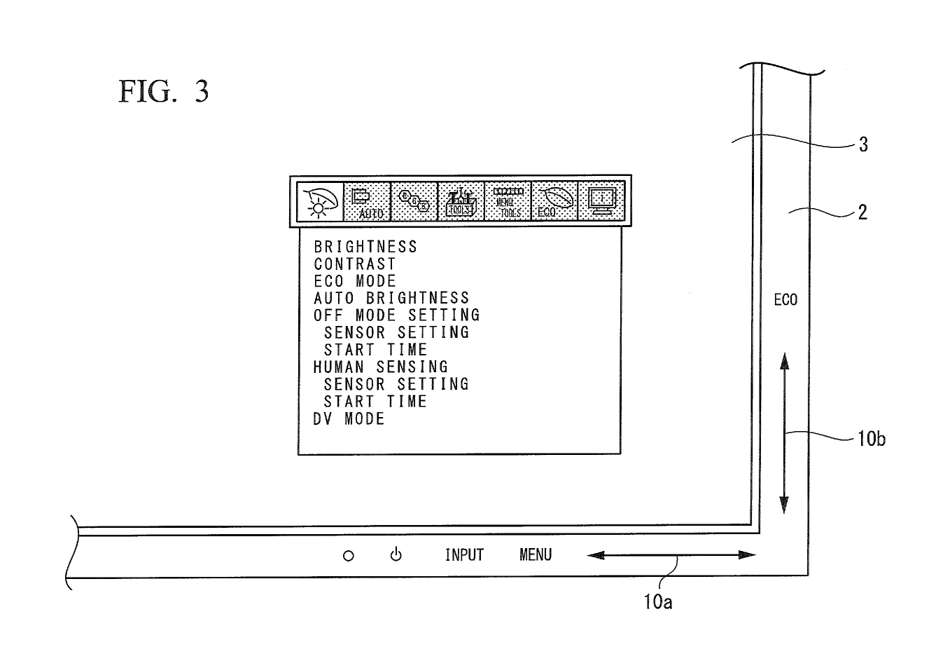

FIG. 3 is a diagram that shows the display position of the OSD screen in the present exemplary embodiment. As shown in the same figure, the OSD screen is displayed in the vicinity of the slider control key 10 that includes the horizontal slider control key 10a and the vertical slider control key 10b. That is to say, the OSD screen is displayed in the vicinity of the bottom-right corner of the display screen 3.

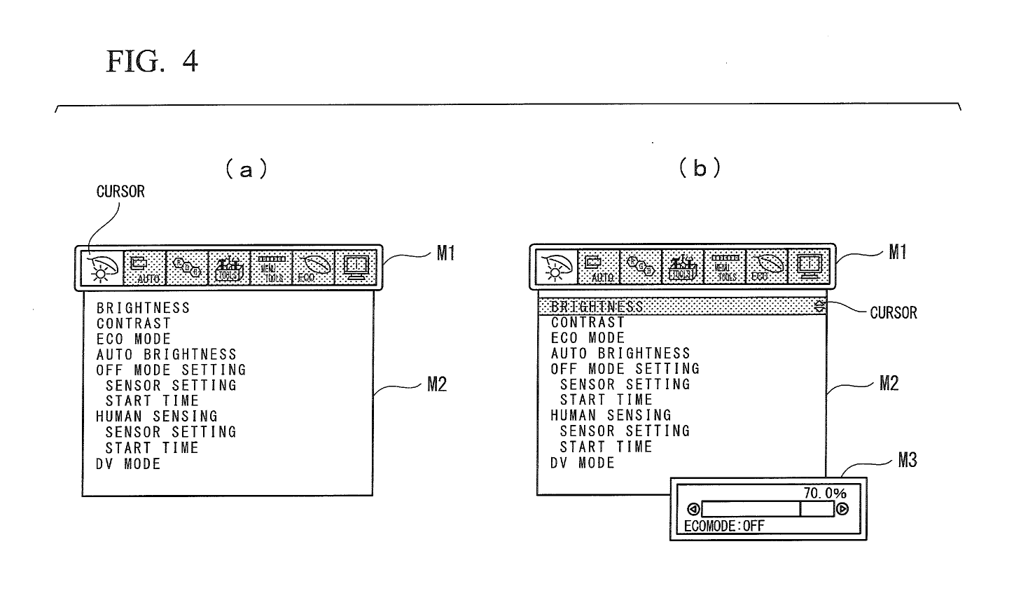

FIG. 4 is a diagram that shows the OSD screen with the cursor located at the main menu, and the OSD screen with the cursor located at the sub-menu.

FIG. 4(a) is a diagram that shows the OSD screen in the state of the cursor being at the main menu. As shown in the same figure, the OSD screen in the state of the cursor being at the main menu M1 includes a main menu M1 that is the menu at the uppermost hierarchy, and a sub-menu M2 that is the menu at the second hierarchy. A list of categories is shown in the main menu M1. In the figure, each category is expressed by an image. In the main menu M1, the image of the category where the cursor is currently placed is shown by a color that is brighter than the images of the other categories. In the case of the cursor being moved to another category, the image of the category at the movement origin is shown by a dark color, while the category image of the movement destination is shown by an image with a bright color. The category where the cursor is placed indicates that the category is currently selected. A list of menu items belonging to the category where the cursor is placed in the main menu M1 is shown in the sub-menu M2.

FIG. 4(b) is a diagram that shows the OSD screen in the state of the cursor being placed at the sub-menu. As shown in the same figure, the image of the category that is presently selected in the main menu M1 is shown by a color that is darker than when the cursor is there, yet brighter than the images of the other categories. Also, in the sub-menu M2, the menu item “BRIGHTNESS” where the cursor is currently placed is shown with a different background color and text color than the other menu items. Then, at the lower-right of the sub-menu M2, a setting screen M3 is displayed for setting the brightness of the screen in which the menu item “BRIGHTNESS” where the cursor is located is the setting target.

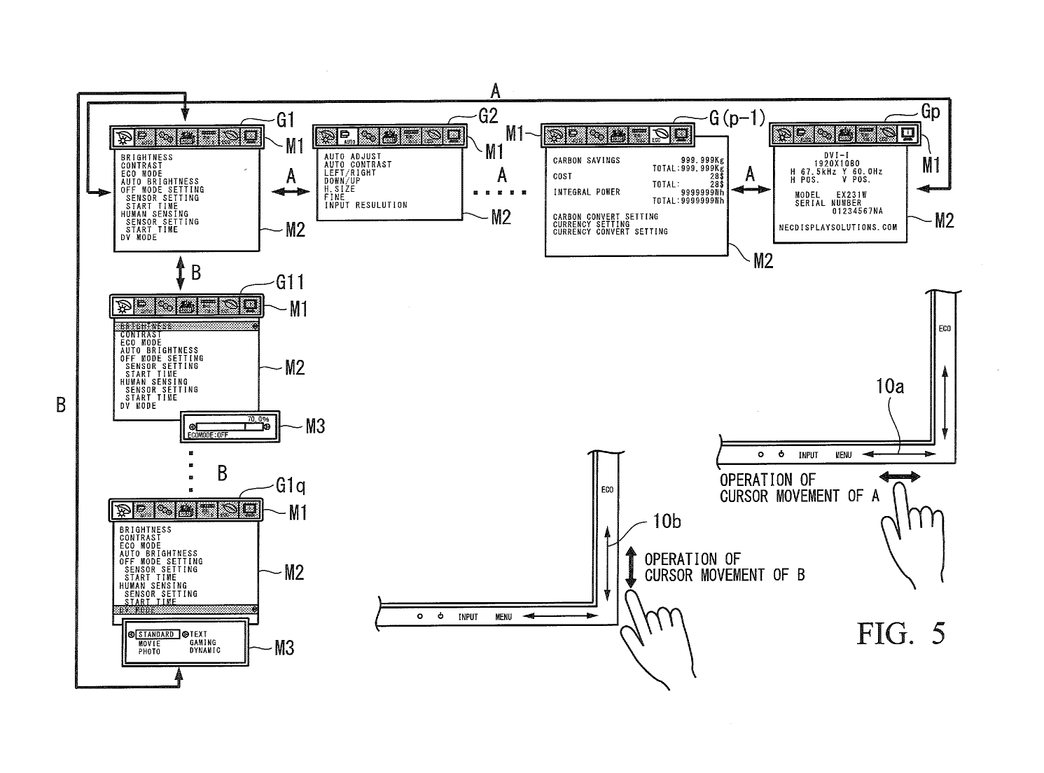

FIG. 5 is a diagram that shows the transition of the OSD screen.

In the OSD screens G1 to Gp (where p is an integer of 2 or more), the cursor is at one category within the main menu M1, while the sub-menu M2 shows the list of menu items that belong to the category where the cursor is placed. Cursor movement within the main menu M1 (reference symbol A) is performed by operation of the horizontal slider control key 10a.

Also, in the OSD screens G11 to G1q (where q is an integer of 1 or more), the menu items that belong to the first category that is selected in the main menu M1 are shown, with the cursor being located at one of those menu items. Also, the setting screen M3 corresponding to the menu item where the cursor is placed is shown. Cursor movement from the main menu M1 to the sub-menu M2, cursor movement within the sub-menu M2, and cursor movement from the sub-menu M2 to the main menu M1 (reference symbol B) are performed by operation of the vertical slider control key 10b.

When the OSD screen display instruction is input to the control unit 4 in the state of the OSD screen not being shown, the input unit 110 outputs an OSD screen display instruction to the controller 120. The operation receiving unit 121 of the controller 120 outputs to the display instruction unit 124 the OSD screen display instruction received from the input unit 110. The display instruction unit 124 generates an image signal of the OSD screen G1 and outputs it to the video display unit 130. The video display unit 130 receives the image signal received from the display instruction unit 124, and displays the OSD screen G1 as default.

In the case of the user tracing with a finger the horizontal slider control key 10a from left to right during display of the OSD screen G1, the display device 1 shows on the display device 3 the video signal of the OSD screen in which the cursor of the main menu M1 has been made to move from the category where the present cursor is currently located to a category to the right by the cursor movement amount corresponding to the distance (operation amount) that the horizontal slider control key 10a has been traced.

Even in the case of the user tracing with a finger the horizontal slider control key 10a from left to right during display of any of the OSD screens G2 to Gp, the same process is performed.

Also, in the case of the user tracing with a finger the horizontal slider control key 10a from right to left during display of any of the OSD screens G1 to Gp, the same process as above is performed, with the input operation direction being leftward.

Note that in the case of the OSD screen Gp at which the cursor is located is at the rightmost category, the screen when the cursor is made to move one position to the right is the OSD screen G1. Also, the screen when the cursor is made to move one position to the left from the OSD screen G1 in which the cursor is located at the leftmost category, is the OSD screen Gp.

In the case of the user tracing with a finger the vertical slider control key 10b from up to down during display of any of the OSD screens G1 to Gp, the display device 1 shows in turn on the display screen 3 the OSD screen in which the cursor in the sub-menu M2 has been made to move from the upper menu item to the lower menu item by the cursor movement amount corresponding to the distance (operation amount) that the vertical slider control key 10b has been traced. For example, in the case of the user tracing with a finger the vertical slider control key 10b from up to down during display of the OSD screen G1, the display device 1 shows in turn on the display screen 3 the OSD screen in which the cursor is made to move from the uppermost menu item “BRIGHTNESS” to the lower menu items by the cursor movement amount corresponding to the traced distance. In this way, the screen in which the cursor is made to move one down from the OSD screen G1 is the OSD screen G11 in which the cursor is at the highest menu item.

Even in the case of the vertical slider control key 10b being traced in the direction from up to down during display of the OSD screen in which the cursor is at any of the menu items of the sub-menu, the display device 1 shows in turn on the display screen 3 the OSD screen in which the cursor of the sub-menu M2 is made to move from the menu item in which the cursor is currently located to a lower menu item.

Note that in the case of the OSD screen G1g in which the cursor is at the last menu item, the screen in which the cursor is moved one position down is the OSD screen G1.

Also, during display of any of the OSD screens G1 to Gp, or during display of a OSD screen in which the cursor is located at any of the menu items of the sub-menu, assuming the input operation direction being from down to up, the same process as mentioned above is performed in the case of the user tracing with a finger the vertical slider control key 10b from the up to down direction.

For example, during display of the OSD screen G1, the user traces the vertical slider control key 10b with a finger from the direction of down to up. The display device 1 shows in turn on the display screen 3 the OSD screen in which the cursor has been made to move from the bottommost menu item “DV MODE” to an upper menu item by the cursor movement amount corresponding to the distance that the vertical slider control key 10b has been traced.

In this way, the screen in which the cursor has moved one up from the OSD screen G1 is the OSD screen G1q. Also, the screen in which the cursor has moved one up from the OSD screen G11 is the OSD screen G1.

The main menu M1 is often used for moving to a menu item of another category. For that reason, the operation of moving from the sub-menu M2 to the main menu M1 is frequently generated. However, the user sometimes operates the slider control key 10 in a manner exceeding correspondence with the cursor movement amount from the screen in which the cursor is currently located in the sub-menu M2 to the screen in which the cursor is at the main menu M1. At this time, even if the user wants to return to the main menu M1, the cursor does not stay at the main menu M1 and goes too far, and again moves to a menu item of the sub-menu.

Therefore, in the present exemplary embodiment, in order to improve operability, in the case of one operation amount to the vertical slider control key 10b exceeding the cursor movement amount to the main menu M1, regardless of the operation amount, the cursor is made to stop once at the main menu M1.

Next, the process sequence of the display device 1 shall be described.

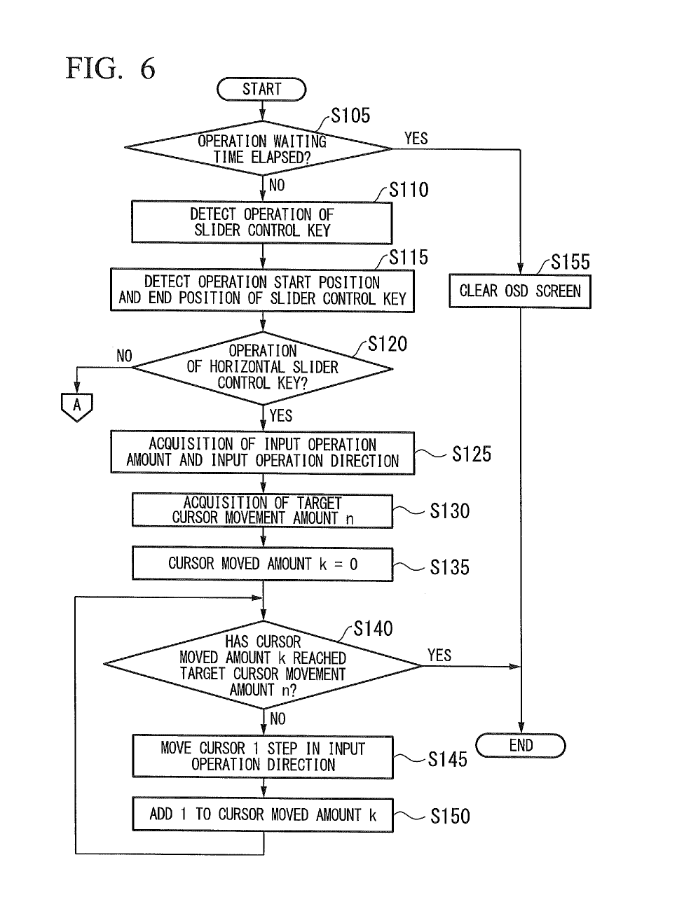

FIG. 6 shows the operation flow of the display device 1 in the state of the OSD screen being shown in which the cursor is located at the main menu M1.

The display instruction unit 124 of the controller 120 counts the time that has elapsed from the current OSD screen being displayed. After the display of the OSD screen, the user traces with a finger the horizontal slider control key 10a or the vertical slider control key prior to the operation waiting time elapsing (Step S105: NO). The first sensor unit 112a or the second sensor unit 112b of the input unit 110 detects the user operation (Step S110: NO).

In the case of the operation of the horizontal slider control key 10a being detected by the first sensor unit 112a, the first sensor processing unit 113a outputs to the controller 120 information that shows the start position and end position of the user operation that the first sensor unit 112a has detected. Alternatively, in the case of an operation of the vertical slider control key 10b being detected by the second sensor unit 112b, the second sensor processing unit 113b outputs to the controller 120 information that shows the start position and end position of the user operation that the second sensor unit 112b has detected (Step S115).

The operation receiving unit 121 of the controller 120 judges whether or not the information received from the input unit 110 is a user operation to the horizontal slider control key 10a detected by the first sensor unit 112a (Step S120). In the case of the operation receiving unit 121 giving the judgment of YES in Step S120 (Step S120: YES), the operation amount calculating unit 122 calculates the difference between the start position and the end position of the user operation shown by the information that the operation receiving unit 121 has received, and makes this calculation result the input operation amount. Moreover, the operation amount calculating unit 122 judges the input operation direction from the relation of the start position and the end position of the user operation (Step S125). The movement amount judging unit 123 judges the cursor movement amount corresponding to the input operation amount calculated in Step S125, from the relation of the input operation amount and the cursor movement amount determined in advance (Step S130). This cursor movement amount serves as the target cursor movement amount n.

The display instruction unit 124 substitutes an initial value of 0 into the cursor moved amount k (Step S135). The display instruction unit 124 judges whether or not the cursor moved amount k has reached the target cursor movement amount n (Step S140). In the case of the display instruction unit 124 judging that the cursor moved amount k has not reached the target cursor movement amount n (Step S140: NO), it generates a video signal for displaying an OSD screen in which the cursor of the main menu M1 of the OSD screen that is currently displayed is advanced one position in the input operation direction, and outputs it to the video display unit 130. The video display unit 130 displays the video signal that it has received (Step S145).

The display instruction unit 124 adds 1 to the cursor moved amount k and update it (Step S150) and executes the process from Step S140. Then, in Step S140, in the case of the display instruction unit 124 judging that the cursor moved amount k has reached the target cursor movement amount n (Step S140: YES), it ends the process.

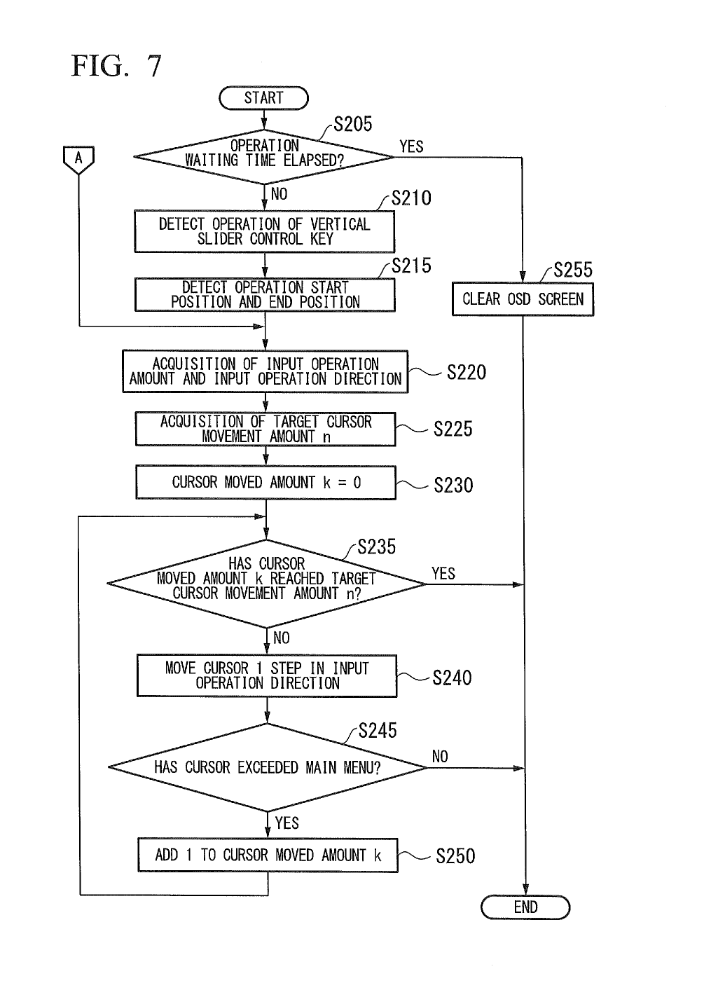

Note that in Step S120, in the case of the operation receiving unit 121 making the judgment NO (Step S120: YES), the process from Step S215 in FIG. 7 described below is performed.

Also, in the case of the display instruction unit 124 judging that the operation waiting time has elapsed (Step S105: YES), it generates a video signal for displaying a screen in which the OSD screen is cleared, and outputs it to the video display unit 130. The video display unit 130 displays the video signal that it has received (Step S155).

FIG. 7 shows the operation flow of the display device 1 in the state of the OSD screen being displayed in which the cursor is located at the sub-menu M2.

The display instruction unit 124 of the controller 120 counts the time that has elapsed since the current OSD screen has been displayed. After display of the OSD screen, the user traces with a finger the vertical slider control key 10b prior to the elapse of the operation waiting time (Step S205: NO). The second sensor unit 112b of the input unit 110 detects the user operation (Step S210). The second sensor processing unit 113b outputs to the controller 120 information that shows the start position and end position of the user operation that the second sensor unit 112b has detected (Step S215). The operating receiving unit 121 of the controller 120 receives the information that shows the start position and end position of the user operation.

The operation amount calculating unit 122 calculates the difference between the start position and the end position of the user operation shown by the information that the operation receiving unit 121 has received, and makes this calculation result the input operation amount. Moreover, the operation amount calculating unit 122 judges the input operation direction from the relation of the start position and the end position of the user operation (Step S220). The movement amount judging unit 123 judges the cursor movement amount corresponding to the input operation amount calculated in Step S220, from the relation of the input operation amount and the cursor movement amount determined in advance (Step S225). This cursor movement amount serves as the target cursor movement amount n.

The display instruction unit 124 substitutes an initial value of 0 into the cursor moved amount k (Step S230). The display instruction unit 124 judges whether or not the cursor moved amount k has reached the target cursor movement amount n (Step S235). In the case of the display instruction unit 124 judging that the cursor moved amount k has not reached the target cursor movement amount n (Step S235: NO), it generates a video signal for displaying an OSD screen in which the cursor of the sub-main menu M2 of the OSD screen that is currently displayed is advanced one position in the input operation direction, and outputs it to the video display unit 130. The video display unit 130 displays the video signal that it has received (Step S240).

In the ease of judging the OSD screen shown in Step S270 to he an OSD screen in which the cursor is not at the main menu M1 (Step S245: NO), the display instruction unit 124 adds 1 to the cursor moved amount k and updates it (Step S250), and executes the process from Step S235. In Step S235, in the case of judging that the cursor moved amount k have reached the target cursor movement amount n (Step S235: YES), the display instruction unit 124 ends the process.

Also, prior to the cursor moved amount k reaching the target cursor movement amount n, in Step S245, the display instruction unit 124, even in the case of having judged that the OSD screen shown in Step S245 is an OSD screen in which the cursor is at the main menu M1 (Step S245: YES), ends the process.

On the other hand, in Step S205, in the case of the display instruction unit 124 judging that the operation waiting time has elapsed (Step S205: YES), it generates a video signal for displaying a screen in which the OSD screen is cleared, and outputs it to the video display unit 130. The video display unit 130 displays the received video signal (Step S255).

The display device 1 of the present exemplary embodiment described above enables menu selection without performing complicated physical operations such as twisting a rotary switch or pressing a button, and so the operation speed is fast and the operability is good.

Also, the OSD screen is displayed on the display screen 2 near the slider control key 10, with operation of the horizontal slider control key 10a made to correspond to category selection from the main menu M1, and operation of the vertical slider control key 10b made to correspond to selection of a menu item from the sub-menu M2. Thereby, the user can intuitively perform operation on the main menu M1 and the sub-menu M2, and operability is good.

Also, since the slider control key 10 is arranged at the bottom right of the front bezel 2, the arm or hand of the user does not block the screen when performing an operation, and it is easy to use for a right-handed user since one's arm does not cross the front of one's body.

Also, there are cases when a user operates the slider control key 10 by an amount greater than the operation amount corresponding to a desired cursor movement amount. Therefore, in the present exemplary embodiment, when the cursor is placed at the sub-menu M2, even in the case of operating the vertical slider control key 10b by an amount greater than the operation amount corresponding to the movement amount for transitioning to a screen in which the cursor is placed at the main menu M1, the cursor is made to stop once at the main menu M1. Thereby, it becomes possible to quickly move to a menu item of another category, and operability is good.

Also, by employing the slider control key 10, since no step is formed in the front bezel 2, there is no increase in the thickness of the display device 1.

Hereinabove, the exemplary embodiment of the present invention has been described, but the controller 120 of the display device 1 shown in FIG. 1 may be constituted with memory and a CPU (central processing unit), and by loading a program for realizing the functions of the controller 120 from memory and running it, may cause those functions to be realized.

Also, the aforementioned program may also be transmitted to another computer system via a transmission medium, or by transmission waves in a transmission medium, from the computer system wherein this program is stored in a storage device or the like. Here, the “transmission medium” for transmitting the program indicates a medium having a function for transmitting information such as a network (telecommunications network) such as the Internet, or telecommunications links (telecommunications lines) such as telephone lines. The program may also have the purpose of implementing some of the functions discussed above. Furthermore, it may also be a so-called differential file (differential program) which can implement the functions discussed above in combination with a program already stored in the computer system.

### Reference Symbols

1 Display device
2 Front bezel
3 Display screen
4 Control unit
10 Slider control key
10a Horizontal slider control key
10b Vertical slider control key
110 Input unit
111a First operation input unit
111b Second operation input unit
112a First sensor unit
112b Second sensor unit
113a First sensor processing unit
113b Second sensor processing unit
120 Controller
121 Operation receiving unit
122 Operation amount calculating unit
123 Movement amount judging unit
124 Display instruction unit
130 Video display unit

1. A display device comprising:
a video display unit that displays an image;
a first operation input unit that detects an operation in a first direction, the operation performed by a user contacting a sensor;
a second operation input unit that detects an operation in a second direction differing from the first direction, the operation performed by a user contacting a sensor;
a front bezel in which the first operation input unit and the second operation input unit are arranged apart on different sides; and
a controller that causes the video display unit to display on-screen display screen including a first hierarchy menu displayed corresponding to the first direction, and a second hierarchy menu displayed corresponding to the second direction, the controller selecting the first hierarchy menu based on the operation detected by the first operation input unit, and the controller selecting the second hierarchy menu based on the operation detected by the second operation input unit.

2. The display device according to claim 1, wherein the control unit causes the video display unit to display the on-screen display screen in which the cursor is moved within the first hierarchy menu in accordance with on an input operation amount and input operation direction detected by the first operation input unit, and the control unit causes the video display unit to display the on-screen display screen in which the cursor is moved within the second hierarchy menu according to an input operation amount and input operation direction detected by the second operation input unit.

3. The display device according to claim 1, wherein the control unit causes the video display unit to display the on-screen display screen in which a cursor is included in the first hierarchy menu, in a case where a cursor movement amount corresponding to an input operation amount and input operation direction detected by the second operation input unit exceeds a range of the second hierarchy menu.

4. The display device according to claim 1, wherein the first operation input unit and the second operation input unit are arranged at bottom right of the front bezel.

5. The display device according to claim 1, wherein the on-screen display screen is displayed near the first operation input unit and the second operation input unit.

6. An on-screen display operation method for a display device, the method comprising:
displaying an image on a video display unit;
detecting an operation in a first direction by a first operation unit, the operation performed by a user contacting a sensor;
detecting an operation in a second direction differing from the first direction by a second operation unit, the operation performed by a user contacting a sensor; and
arranging a front bezel in which the first operation input unit and the second operation input unit are arranged apart on different sides;
causing the video display unit to display on-screen display screen including a first hierarchy menu displayed corresponding to the first direction, and a second hierarchy menu displayed corresponding to the second direction;
performing a process of selection of the first hierarchy menu based on the operation detected by the first operation input unit; and
performing a process of selection of the second hierarchy menu based on the operation detected by the second operation input unit.

7. The display device according to claim 2, wherein the control unit causes the video display unit to display the on-screen display screen in which a cursor is included in the first hierarchy menu, in a case where a cursor movement amount corresponding to an input operation amount and input operation direction detected by the second operation input unit exceeds a range of the second hierarchy menu.

8. The display device according to claim 2, wherein the first operation input unit and the second operation input unit are arranged at bottom right of the front bezel.

9. The display device according to claim 3, wherein the first operation input unit and the second operation input unit are arranged at bottom right of the front bezel.

10. The display device according to claim 2, wherein the on-screen display screen is displayed near the first operation input unit and the second operation input unit.

11. The display device according to claim 3, wherein the on-screen display screen is displayed near the first operation input unit and the second operation input unit.

12. The display device according to claim 4, wherein the on-screen display screen is displayed near the first operation input unit and the second operation input unit.
